(19) United States
(12) Patent Application Publication
(10) Pub. No.: US 2015/0252196 A1
(43) Pub. Date: Sep. 10, 2015

(54) Coatable Composition, Wear-Resistant Composition, Wear-Resistant Articles, and Methods of Making the Same

(71) Applicant: 3M INNOVATIVE PROPERTIES COMPANY, Saint Paul, MN (US)

(72) Inventors: Naiyong Jing, Woodbury, MN (US); Xuan Jiang, Maplewood, MN (US); Justin A. Riddle, St. Paul, MN (US); Fuxia Sun, Woodbury, MN (US); Christiane Strerath, Dusseldorf (DE); Xue-hua Chen, Shanghai (CN)

(73) Assignee: 3M INNOVATIVE PROPERTIES COMPANY, St. Paul, MN (US)

(21) Appl. No.: 14/430,483

(22) PCT Filed: Sep. 20, 2013
(86) PCT No.: PCT/US2013/060972

§ 371 Date: Mar. 23, 2015

Related U.S. Application Data
(60) Provisional application No. 61/705,917, filed on Sep. 26, 2012.

(51) Int. Cl. C09D 1/00; C08K 3/16; C08K 3/28; C08K 3/36

(52) U.S. Cl. CPC C09D 1/00; C08K 3/36; C08K 3/16; C08K 3/28

(57) ABSTRACT

A method of making a coatable composition includes: a) providing a initial composition comprising silica nanoparticles dispersed in an aqueous liquid medium, wherein the silica nanoparticles have a particle size distribution with an average particle size of less than or equal to 20 nanometers, and wherein the silica sol has a pH greater than 6; b) acidifying the initial composition to a pH of less than or equal to 4 using inorganic acid to provide an acidified composition; and c) dissolving at least one metal compound in the acidified composition to provide a coatable composition. Coatable compositions, wear-resistant compositions, preparable by the method are also disclosed. Wear-resistant articles including the wear-resistant compositions are also disclosed

### TECHNICAL FIELD

The present disclosure relates broadly to articles with wear-resistant properties, compositions that form wear-resistant coatings, and methods for making the same.

### BACKGROUND

Wear-resistant coatings are widely used in industry. The coatings enhance durability of articles where damage from abrasion is a concern. Damage due to abrasion can detract from the aesthetic value of such articles as include architectural surfaces and advertising media. Some wear-resistant coatings are prone to discoloration. In some cases, excessive wear may affect important functional visual properties as well, such as, for example, visibility in the case of retroreflective road signage or intensity in the case of headlight covers.

### SUMMARY

In one aspect, the present disclosure provides a method of making a coatable composition, the method comprising:

providing a first composition comprising silica nanoparticles dispersed in an aqueous liquid medium, wherein the silica nanoparticles have an average particle size of less than or equal to 20 nanometers, wherein the first composition has a pH greater than 6;

dissolving at least one metal compound in the coatable composition, wherein the metal compound comprises a metal cation having a charge of n+, wherein n represents an integer ≧2; and

acidifying the first composition to a pH of less than or equal to 4 using inorganic acid to provide the coatable composition, wherein the coatable composition comprises agglomerated silica nanoparticles.

In another aspect, the present disclosure provides a coatable composition made according to the foregoing method.

Coatable compositions according to the present disclosure are useful, for example, for making wear-resistant articles.

Accordingly, in yet another aspect, the present disclosure provides a method of making a wear-resistant article, the method comprising steps:

a) providing a first composition comprising silica nanoparticles dispersed in an aqueous liquid medium, wherein the silica nanoparticles have an average particle size of less than or equal to 20 nanometers, wherein the first composition has a pH greater than 6;

b) acidifying the composition to a pH of less than or equal to 4 using inorganic acid to provide a second composition; and

c) dissolving at least one metal compound in the second composition to provide a coatable composition, wherein the metal compound comprises a metal cation having a charge of n+, wherein n represents an integer ≧2; and

d) coating a layer of the coatable composition onto a surface of a substrate; and

e) at least partially drying the coatable composition to provide a wear-resistant layer.

In yet another aspect, the present disclosure provides a wear-resistant article made according to the foregoing method of the present disclosure.

In yet another aspect, the present disclosure provides a wear-resistant composition comprising an amorphous silica matrix containing metal cations, wherein the amorphous silica matrix comprises interconnected silica nanoparticles having a particle size distribution with an average particle size of less than or equal to 20 nanometers, wherein the metal cations have a charge of n+, wherein n represents an integer ≧2, wherein a majority of the metal cations are individually disposed in the amorphous silica matrix, and wherein the metal cations comprise from 0.5 to 20 mole percent of the composition.

In yet another aspect, the present disclosure provides a wear-resistant article comprising a layer of an amorphous wear-resistant composition disposed on a surface of a substrate, wherein the amorphous wear-resistant composition comprises a silica matrix containing metal cations, wherein the silica matrix comprises interconnected silica nanoparticles having a particle size distribution with an average particle size of less than or equal to 20 nanometers, wherein the metal cations have a charge of n+, wherein n represents an integer ≧2, wherein a majority of the metal cations are individually disposed in the silica matrix, and wherein the metal cations comprise from 0.5 to 20 mole percent of the amorphous wear-resistant composition.

As used herein:

the term “dispersion of silica nanoparticles” refers to a dispersion wherein individual silica nanoparticles are dispersed, and does not refer to a dispersion of fumed silica, which has sintered primary silica particles aggregated into chains;

the term “essentially free of” means containing less than one by percent by weight of, typically less than 0.1 percent by weight of, and more typically less than 0.01 percent by weight of;

the term “essentially free of non-volatile organic compounds” means containing less than one percent by weight of organic compounds having a boiling point above 150° Celsius at 1 atmosphere (100 kPa) of pressure;

the term “individually disposed in the amorphous silica matrix” in reference to metal cations means that the metal cations are bound through oxygen to silicon, and are not present as a discrete metal oxide phase;

the term “nanoparticle” refers to a particle having a particle size of from 1 to 200 nanometers;

the term “organic compound” refers to any compound containing at least one carbon-carbon and/or carbon-hydrogen bond;

the term “silica”, used in reference to silica nanoparticles and silica sols, refers to a compound represented by the formula SiO₂.nH₂O, wherein n is a number greater than or equal to zero.

Advantageously, wear-resistant layers, and articles including them, according to the present disclosure may exhibit good mechanical durability and/or wear-resistant properties.

Features and advantages of the present disclosure will be further understood upon consideration of the detailed description as well as the appended claims.

### BRIEF DESCRIPTION OF THE DRAWINGS

FIG. 1 is a schematic side view of an exemplary wear-resistant article 100 according to the present disclosure.

It should be understood that numerous other modifications and embodiments can be devised by those skilled in the art, which fall within the scope and spirit of the principles of the disclosure. The FIGURE may not be drawn to scale.

### DETAILED DESCRIPTION

The initial composition comprises silica nanoparticles dispersed in an aqueous liquid medium, wherein the silica nanoparticles have a particle size distribution with an average particle size of less than or equal to 20 nanometers, and wherein the initial composition has a pH greater than 6.

The silica nanoparticles have an average particle size of less than or equal to 20 nanometers (nm). In some embodiments, the silica nanoparticles have an average particle size of less than or equal to 20 nm, less than or equal to 15 nm, less than or equal to 10 nm, less than or equal to 8 nm, or even less than or equal to 4. Typically, the silica nanoparticles have an average particle size of at least 4 nm, although this is not a requirement. The average primary particle size may be determined, for example, using transmission electron microscopy. As used herein, the term “particle size” refers to the longest dimension of a particle, which is the diameter for a spherical particle.

Of course, silica particles with a particle size greater than 200 nm (e.g., up to 2 micrometers in particle size) may also be included, but typically in a minor amount.

The silica nanoparticles desirably have narrow particle size distributions; for example, a polydispersity of 2.0 or less, or even 1.5 or less. In some embodiments, the silica nanoparticles have a surface area greater than 150 square meters per gram (m²/g), greater than 200 m²/g, or even greater than 400 m²/g.

In some embodiments, the total weight of the silica nanoparticles in the initial composition is at least 0.1 percent by weight, typically at least 1 percent by weight, and more typically at least 2 percent by weight. In some embodiments, the total weight of the silica nanoparticles in the composition is no greater than 40 percent by weight, preferably no greater than 10 percent by weight, and more typically no greater than 7 percent by weight, based on the total weight of the initial composition.

The silica nanoparticles may have a polymodal particle size distribution.

Nanoparticles (e.g., silica nanoparticles) included in the initial composition can be spherical or non-spherical with any desired aspect ratio. Aspect ratio refers to the ratio of the average longest dimension of the nanoparticles to their average shortest dimension. The aspect ratio of non-spherical nanoparticles is often at least 2:1, at least 3:1, at least 5:1, or at least 10:1. Non-spherical nanoparticles may, for example, have the shape of rods, ellipsoids, and/or needles. The shape of the nanoparticles can be regular or irregular. The porosity of coatings can typically be varied by changing the amount of regular and irregular-shaped nanoparticles in the coatable composition and/or by changing the amount of spherical and non-spherical nanoparticles in the coatable composition.

In some embodiments, the total weight of the silica nanoparticles in the initial composition is at least 0.1 percent by weight, typically at least 1 percent by weight, and more typically at least 2 percent by weight. In some embodiments, the total weight of the silica nanoparticles in the composition is no greater than 40 percent by weight, desirably no greater than 10 percent by weight, and more typically no greater than 7 percent by weight.

Silica sols, which are stable dispersions of silica nanoparticles in aqueous liquid media, are well-known in the art and available commercially. Non-aqueous silica sols (also called silica organosols) may also be used and are silica sol dispersions wherein the liquid phase is an organic solvent, or an aqueous mixture containing an organic solvent. In the practice of this disclosure, the silica sol is chosen so that its liquid phase is compatible with the dispersion, and is typically an aqueous solvent, optionally including an organic solvent. Typically, the initial composition does not include, or is essentially free of, fumed silica, although this is not a requirement.

Silica nanoparticle dispersions (e.g., silica sols) in water or water-alcohol solutions are available commercially, for example, under such trade names as LUDOX (marketed by E. I. du Pont de Nemours and Co., Wilmington, Del.), NYACOL (marketed by Nyacol Co., Ashland, Mass.), and NALCO (manufactured by Ondea Nalco Chemical Co., Oak Brook, Ill.). One useful silica sol is NALCO 2326, which is available as a silica sol with an average particle size of 5 nanometers, pH=10.5, and solid content 15 percent solids by weight. Other commercially available silica nanoparticles include those available under the trade designations NALCO 1115 (spherical, average particle size of 4 nm, 15 percent solids by weight dispersion, pH=10.4), NALCO 1130 spherical dispersion, average particle size of 8 nm, 30 percent solids by weight dispersion, pH=10.2), NALCO 1050 (spherical, average particle size 20 nm, 50 percent solids by weight dispersion, pH=9.0), NALCO 2327 (spherical, average particle size of 20 nm, 40 percent solids by weight dispersion, pH=9.3), NALCO 1030 (spherical, average particle size of 13 nm, 30 percent solids by weight dispersion, pH=10.2).

Acicular silica nanoparticles may also be used provided that the average silica nanoparticle size constraints described hereinabove are achieved.

Useful acicular silica nanoparticles may be obtained as an aqueous suspension under the trade name SNOWTEX-UP by Nissan Chemical Industries (Tokyo, Japan). The mixture consists of 20-21% (w/w) of acicular silica, less than 0.35% (w/w) of Na₂O, and water. The particles are about 9 to 15 nanometers in diameter and have lengths of 40 to 200 nanometers. The suspension has a viscosity of <100 mPa at 25° C., a pH of about 9 to 10.5, and a specific gravity of about 1.13 at 20° C.

Other useful acicular silica nanoparticles may be obtained as an aqueous suspension under the trade name SNOWTEX-PS-S and SNOWTEX-PS-M by Nissan Chemical Industries, having a morphology of a string of pearls. The mixture consists of 20-21% (w/w) of silica, less than 0.2% (w/w) of Na₂O, and water. The SNOWTEX-PS-M particles are about 18 to 25 nanometers in diameter and have lengths of 80 to 150 nanometers. The particle size is 80 to 150 by dynamic light scattering methods. The suspension has a viscosity of <100 mPas at 25° C., a pH of about 9 to 10.5, and a specific gravity of about 1.13 at 20° C. The SNOWTEX-PS-S has a particle diameter of 10-15 nm and a length of 80-120 nm.

Low- and non-aqueous silica sols (also called silica organosols) may also be used and are silica sol dispersions wherein the liquid phase is an organic solvent, or an aqueous organic solvent. In the practice of the present disclosure, the silica nanoparticle sol is chosen so that its liquid phase is compatible with the intended coating composition, and is typically aqueous or a low-aqueous organic solvent.

Silica sols having a pH of at least 8 can also be prepared according to the methods described in U.S. Pat. No. 5,964,693 (Brekau et al.).

Optionally, the initial composition can further include other nanoparticles, including, for example, nanoparticles comprising aluminum oxide, titanium oxide, tin oxide, antimony oxide, antimony-doped tin oxide, indium oxide, tin-doped indium oxide, or zinc oxide.

The initial composition has a pH greater than 6, more typically greater than 7, more typically greater than 8, and even more typically greater than 9.

In some embodiments, the initial composition is essentially free of non-volatile organic compounds. In some embodiments, the initial composition is essentially free of organic surfactants.

The aqueous liquid medium of the initial composition may comprise (in addition to water) at least one volatile organic solvent. Examples of suitable volatile organic solvents include those volatile organic solvents that are miscible with water such as, e.g., methanol, ethanol, isopropanol, and combinations thereof. However, for many applications, reduction or elimination of volatile organic compounds will be desirable, and advantageously the present disclosure may be practiced using initial compositions and/or coatable compositions that are essentially free of volatile organic solvent.

The initial composition is acidified by addition of inorganic acid until it has a pH of less than or equal to 4, typically less than 3, or even less than 2 thereby providing the coatable composition. Useful inorganic acids (i.e., mineral acids) include, for example, hydrochloric acid, nitric acid, sulfuric acid, phosphoric acid, perchloric acid, chloric acid, and combinations thereof. Typically, the inorganic acid is selected such that it has a pKₐ of less than or equal to two, less than one, or even less than zero, although this is not a requirement. Without wishing to be bound by theory, the present inventors believe that some agglomeration of the silica nanoparticles occurs as the pH falls, resulting in a dispersion comprising slightly agglomerated nanoparticles.

At this stage, at least one metal compound may be combined with (e.g., dissolved in) the acidified composition thereby providing the coatable composition, generally with mixing. Combination of the various ingredients in the above compositions may be carried out using any suitable mixing technique. Examples include stirring, shaking, and otherwise agitating the composition during or after addition of all components of the composition.

The metal compound (and any metal cations contained therein) may comprise a metal (or metal cation) in any of groups 2 through 15 (e.g., group 2, group 3, group 4, group 5, group 6, group 7, group 8, group 9, group 10, group 11, group 12, group 13, group 14, group 15, and combinations thereof) of the Periodic Table of the Elements.

Metal cations contained in the metal compound(s) may have a charge of n+, wherein n represents an integer ≧2 (e.g., 2, 3, 4, 5, or 6), for example. The metal compounds should have sufficient solubility in water to achieve the desired level of metal incorporation in the resultant wear-resistant composition. For example, the metal compound(s) may comprise metal compound(s). Examples of useful metal compounds include copper compounds (e.g., CuCl₂.2H₂O), aluminum compounds (e.g., Al(NO₃)₃.9H₂O), zirconium compounds (e.g., ZrCl₄ or ZrOCl₂.8H₂O), titanium compounds (e.g., TiOSO₄.2H₂O), zinc compounds (e.g. Zn(NO₃)₂.6H₂O), iron compounds, tin compounds (e.g., SnCl₄.5H₂O or SnCl₂), and combinations thereof.

Coatable compositions according to the present disclosure may further comprise one or more optional additives such as, for example, colorant(s), surfactant(s), thickener(s), thixotrope(s), or leveling aid(s). Optional other ingredients

In some embodiments, the coatable composition may comprise an added surfactant, however, the inventors have unexpected discovered that coatable compositions according to the present disclosure wet out at least some hydrophobic surfaces without added surfactant.

The coatable composition may comprise from 30 to 99 percent by weight of silica, preferably from 60 to 97.5 percent by weight of silica, more preferably from 80 to 95 percent by weight of silica, although other amounts may also be used.

Similarly, the coatable composition may comprise the metal cations in an amount of from 0.2 to 20 mole percent (desirably from 0.5 to 10 mole percent, more desirably from 2 to 5 mole percent) of the total combined moles of silicon and the metal cations (e.g., having a positive charge of at least 2) contained in the metal compound(s), although other amounts may also be used.

Once made, the coating composition is typically stable over long periods of time, over a range of temperatures, although this is not a requirement. The coating composition may be coated onto a substrate and at least partially dried, typically substantially completely dried.

Without wishing to be bound by theory, the present inventors believe that during the drying process, condensation processes lead to chemical bonding between the silica nanoparticles and/or agglomerates at points of contact to form a silica matrix. Metal cations may be individually incorporated into the silica matrix, resulting in an amorphous composition.

The coatable composition can be contacted with a surface of a substrate and at least partially dried to form a wear-resistant coated article. Unexpectedly, the present inventors have discovered that coatable compositions according to the present disclosure can be contacted with a surface of a substrate and at least partially dried to provide a defect-free layer with unexpected wear-resistant properties, even without added metal cations. Suitable methods of drying the coatable composition include, for example, evaporation in air at about room temperature, ovens, heated air blowers, infrared heaters, and hot cans. Drying is typically carried out until the coatable composition is substantially completely dry, although this is not a requirement. Once contacted with the substrate and at least partially dried, the wear-resistant layer may be aged for a period of time such as for example, at least 1 hour (hr), at least 4 hrs, at least 8 hrs, at least 24 hrs, at least 72 hrs, at least 1 week, or even at least 2 weeks, during which time the wear-resistance of the wear-resistant layer may improve.

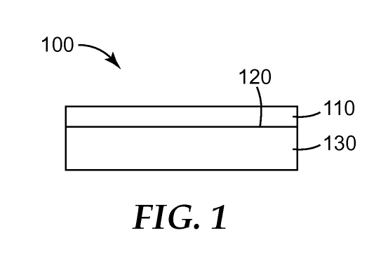

Referring now to FIG. 1, wear-resistant article 100 comprises wear-resistant layer 110 disposed on surface 120 of substrate 130. Examples of suitable methods of contact the coatable composition with the surface of the substrate include roll coating, spray coating, gravure coating, dip coating, and curtain coating. Typically, the wear-resistant layer has a thickness in the range of from 0.02 to 100 microns, preferably 0.05 to 5 microns, although this is not a requirement.

Typically, wear-resistant layers according to the present disclosure are at least substantially transparent, however this is not a requirement.

Examples of suitable substrates include virtually any dimensionally-stable material. Examples include glass substrates (e.g., mirrors, windows, windshields, tables, lenses, and prisms), metal substrates, ceramic substrates, organic polymer substrates (e.g., molded polymer articles, automotive paints and clearcoats, polymer films, retroreflective sheeting, indoor signage, and outdoor signage), and fabric (e.g., upholstery fabric). In some embodiments, the substrate comprises at least one of glass or an organic polymer. In some embodiments, the organic polymer comprises at least one of a polyester (e.g., polyethylene terephthalate or polybutylene terephthalate), polycarbonate, allyldiglycol carbonate, acrylics (e.g., polymethyl methacrylate (PMMA)), polystyrene, polysulfone, polyether sulfone, homo-epoxy polymers, epoxy addition polymers with polydiamines and/or polydithiols, polyamides (e.g., nylon 6 and nylon 6,6), polyimides, polyolefins (e.g., polyethylene and polypropylene), olefinic copolymers (e.g., polyethylene copolymers), and cellulose esters (e.g., cellulose acetate and cellulose butyrate), and combinations thereof.

### Select Embodiments of the Present Disclosure

In a first embodiment, the present disclosure provides a method of making a coatable composition, the method comprising:

providing a first composition comprising silica nanoparticles dispersed in an aqueous liquid medium, wherein the silica nanoparticles have an average particle size of less than or equal to 20 nanometers, wherein the first composition has a pH greater than 6;

dissolving at least one metal compound in the coatable composition, wherein the metal compound comprises a metal cation having a charge of n+, wherein n represents an integer ≧2; and

acidifying the first composition to a pH of less than or equal to 4 using inorganic acid to provide the coatable composition, wherein the coatable composition comprises agglomerated silica nanoparticles.

In a second embodiment, the present disclosure provides a method according to the first embodiment, wherein said at least one metal compound is selected from the group consisting of tin compounds, zinc compounds, aluminum compounds, zirconium compounds, copper compounds, and combinations thereof.

In a third embodiment, the present disclosure provides a method according to the first or second embodiment, wherein the coatable composition is essentially free of organic non-volatile compounds.

In a fourth embodiment, the present disclosure provides a method according to any one of the first to third embodiments, wherein said at least one metal compound comprises from 0.5 to 20 mole percent based on the total moles of silica and said at least one metal compound in the coatable composition.

In a fifth embodiment, the present disclosure provides a coatable composition made according to the method of any one of the first to fourth embodiments.

In a sixth embodiment, the present disclosure provides a method of making a wear-resistant article, the method comprising steps:

a) providing a first composition comprising silica nanoparticles dispersed in an aqueous liquid medium, wherein the silica nanoparticles have an average particle size of less than or equal to 20 nanometers, wherein the first composition has a pH greater than 6;

b) acidifying the composition to a pH of less than or equal to 4 using inorganic acid to provide a second composition; and

c) dissolving at least one metal compound in the second composition to provide a coatable composition, wherein the metal compound comprises a metal cation having a charge of n+, wherein n represents an integer ≧2; and

d) coating a layer of the coatable composition onto a surface of a substrate; and

e) at least partially drying the coatable composition to provide a wear-resistant layer.

In a seventh embodiment, the present disclosure provides a method according to the sixth embodiment, wherein said at least one metal compound is selected from the group consisting of tin compounds, zinc compounds, aluminum compounds, zirconium compounds, copper compounds, and combinations thereof.

In an eighth embodiment, the present disclosure provides a method according to the sixth or seventh embodiment, wherein said at least one metal compound comprises from 0.5 to 20 mole percent based on the total moles of silica and said at least one metal compound in the coatable composition.

In a ninth embodiment, the present disclosure provides a method according to any one of the sixth to eighth embodiments, wherein the substrate comprises glass or organic polymer.

In a tenth embodiment, the present disclosure provides a method according to any one of the sixth to ninth embodiments, wherein the organic polymer comprises at least one of polyethylene terephthalate or polymethyl methacrylate.

In an eleventh embodiment, the present disclosure provides a method according to any one of the sixth to tenth embodiments, wherein the wear-resistant layer is optically clear.

In a twelfth embodiment, the present disclosure provides a method according to any one of the sixth to eleventh embodiments, wherein the wear-resistant layer has a thickness in a range of from 0.1 to 100 microns.

In a thirteenth embodiment, the present disclosure provides a method according to any one of the sixth to twelfth embodiments, wherein the inorganic acid has a pKₐ of less than or equal to zero.

In a fourteenth embodiment, the present disclosure provides a method according to any one of the sixth to thirteenth embodiments, wherein step b) comprises acidifying the first composition to a pH of less than or equal to 2.

In a fifteenth embodiment, the present disclosure provides a method according to any one of the sixth to fourteenth embodiments, wherein the coatable composition is essentially free of organic non-volatile compounds.

In a sixteenth embodiment, the present disclosure provides a wear-resistant article made according to the method of any one of the sixth to fifteenth embodiments.

In a seventeenth embodiment, the present disclosure provides a wear-resistant article according to the sixteenth embodiment, wherein the article comprises retroreflective sheeting.

In an eighteenth embodiment, the present disclosure provides a wear-resistant composition comprising an amorphous silica matrix containing metal cations, wherein the amorphous silica matrix comprises interconnected silica nanoparticles having a particle size distribution with an average particle size of less than or equal to 20 nanometers, wherein the metal cations have a charge of n+, wherein n represents an integer ≧2, wherein a majority of the metal cations are individually disposed in the amorphous silica matrix, and wherein the metal cations comprise from 0.5 to 20 mole percent of the composition.

In a nineteenth embodiment, the present disclosure provides a wear-resistant composition according to the eighteenth embodiment, wherein the metal cations are selected from the group consisting of tin compounds, zinc compounds, aluminum compounds, zirconium compounds, copper compounds, and combinations thereof.

In a twentieth embodiment, the present disclosure provides a wear-resistant composition according to the eighteenth or nineteenth embodiment, wherein the silica nanoparticles have an average particle size of less than or equal to 10 nanometers.

In a twenty-first embodiment, the present disclosure provides a wear-resistant composition according to any one of the eighteenth to twentieth embodiments, wherein the wear-resistant composition is essentially free of organic non-volatile compounds.

In a twenty-second embodiment, the present disclosure provides a wear-resistant article comprising a layer of an amorphous wear-resistant composition disposed on a surface of a substrate, wherein the amorphous wear-resistant composition comprises a silica matrix containing metal cations, wherein the silica matrix comprises interconnected silica nanoparticles having a particle size distribution with an average particle size of less than or equal to 20 nanometers, wherein the metal cations have a charge of n+, wherein n represents an integer ≧2, wherein a majority of the metal cations are individually disposed in the silica matrix, and wherein the metal cations comprise from 0.5 to 20 mole percent of the amorphous wear-resistant composition.

In a twenty-third embodiment, the present disclosure provides a wear-resistant article according to the twenty-second embodiment, wherein said at least one metal compound is selected from the group consisting of tin compounds, zinc compounds, aluminum compounds, zirconium compounds, copper compounds, and combinations thereof.

In a twenty-fourth embodiment, the present disclosure provides a wear-resistant article according to the twenty-second of twenty-third embodiment, wherein the silica nanoparticles have an average particle size of less than or equal to 10 nanometers.

In a twenty-fifth embodiment, the present disclosure provides a wear-resistant article according to any one of the twenty-second to twenty-fourth embodiments, wherein the substrate comprises glass or an organic polymer.

In a twenty-sixth embodiment, the present disclosure provides a wear-resistant article according to any one of the twenty-second to twenty-fifth embodiments, wherein the organic polymer comprises at least one of polymethyl methacrylate or polyethylene terephthalate.

In a twenty-seventh embodiment, the present disclosure provides a wear-resistant article according to any one of the twenty-second to twenty-sixth embodiments, wherein the wear-resistant layer is optically clear.

In a twenty-eighth embodiment, the present disclosure provides a wear-resistant article according to any one of the twenty-second to twenty-seventh embodiments, wherein the wear-resistant layer has a thickness in a range of from 0.02 to 100 microns.

In a twenty-ninth embodiment, the present disclosure provides a wear-resistant article according to any one of the twenty-second to twenty-eighth embodiments, wherein the coatable composition is essentially free of organic non-volatile compounds.

In a thirtieth embodiment, the present disclosure provides a wear-resistant article according to any one of the twenty-second to twenty-ninth embodiments, wherein the substrate comprises retroreflective sheeting.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples are by weight.

### Materials:

Nitric acid was obtained from VWR international, West Chester, Pa.

NALCO 1115 (4 nm average particle diameter) colloidal silica was obtained from Nalco Company, Naperville, Ill. under the trade designations NALCO 1115 colloidal silica.

NALCO 1050 (20 nm average particle diameter) colloidal silica was obtained from Nalco Company under the trade designation NALCO 1050 colloidal silica.

SnCl₄.5H₂O was obtained from Sigma-Aldrich Co., Saint Louis, Mo.

TiOSO₄.2H₂O was obtained from Sigma-Aldrich Co.

Al(NO₃)₃.9H₂O was obtained from Sigma-Aldrich Co.

Zn(NO₃)₂.6H₂O was obtained from Sigma-Aldrich Co.

Cu(NO₃)₂.3H₂O was obtained from Sigma-Aldrich Co.

### Test Methods for Evaluating the Mechanical Durability

Method 1 (Crock test): The samples prepared according to the Examples described below were evaluated the mechanical durability using a TABER 5900 Reciprocating Abraser (purchased from TABER INDUSTRIES, N. Tonawanda, N.Y.). This is a test apparatus similar to the instrument described in standard test method ISO 1518. The film samples were cut to 5×10 cm rectangular size and taped on the specimen platform with a same size paper towel beneath. Test parameters were set up the same for all samples (stoke length 5 cm, speed 15 cycles per minute, load 13.5N). Different type of materials (KIMWIPES 34155 paper wipers obtained from Kimberly-Clark Worldwide, Inc. Roswell, Ga., and Crockmeter standard rubbing cloth (Crock Cloth) obtained from Testfabrics, Inc. West Pittston, Pa.) were used for testing. Two types of data were recorded, both based on an average of three individual results from reciprocating abrasion tests. The first was the number of cycles recorded when the coating started to be scratched.

Method 2 (Haze Increase): The second data was haze change collected from a HAZE-GARD PLUS (purchased from BYK-Gardner, Geretsried, Germany) according to ASTM D1003-11e1 Standard Test Method for Haze and Luminous Transmittance of Transparent Plastics before and after the abrasion tests.

### Examples 1-12 and Comparative Examples A-E

Examples 1-4 and Comparative Examples A-B were prepared by diluting colloidal silica dispersion NALCO 1115 (4 nm) to 10 weight percent solids with deionized water, and then acidifying it with concentrated HNO₃ to pH=2. Examples 5-12 and Comparative Examples C-E were prepared by mixing diluted silica dispersions NALCO 1115 (10 weight percent) and NALCO 1050 (20 nm, 10 weight percent) with a ratio of 30:70 respectively, then acidifying with concentrated HNO₃ to pH=2. The zirconium compound solution (ZrOCl₂.8H₂O) (10 weight percent solution in water) were subsequently added to the respective silica solution of Examples 1-4 to result in a metal salt concentration from 5 to 10 weight percent to the total solids in the coating mixture. Other metal salts (SnCl₄.5H₂O (10 weight percent solution in water), TiOSO₄.2H₂O (10 weight percent solution in water), Al(NO₃)₃.9H₂O (10 weight percent solution in water), Zn(NO₃)₂.6H₂O (10 weight percent solution in water), Cu(NO₃)₂.3H₂O (10 weight percent solution in water)) were subsequently added to the respective silica solution of Examples 5-12 to result in a metal compound concentration 5 weight percent to the total solids in the coating mixture. The composition of coating solutions and substrates for each of Examples 1-12 and Comparative Examples A-E are reported in the Table 1 and 2.

The coated samples for each Example were prepared by coating metal doped silica dispersion on 50 micrometer thick polyethylene terephthalate films obtained from E.I. du Pont de Nemours and Co, Wilmington, Del., under the trade designation MELINEX 618 (hereinafter PET) substrates or flashlamp-treated PET with #12 wire-wound coating rod (from RD Specialties, Webster, N.Y., nominal wet coating thickness=28 microns). The coating samples were dried at room temp and then further cured at 120° C. for 10 min. The final samples were optically clear and transparent.

The samples thus prepared were tested according to the TEST METHODS FOR EVALUATING THE MECHANICAL DURABILITY described above. Results are reported in Tables 1 and 2 (below), wherein “NA” means “not applicable”.

TABLE 1

| | SILICA | | | CROCK TEST |
|---|---|---|---|---|
| | DISPERSION, | | | CYCLES TO |
| | (weight ratio, | ZrOCl₂•8H₂O | | FAILURE |
| EXAM- | total weight | weight percent | SUB- | WITH PAPER |
| PLE | percent solids) | of total solids | STRATE | TOWEL |
| COMP. | NALCO 1115 | 0.0 | PET | <10 |
| EX. A | (NA, 10) | | | |
| 1 | NALCO 1115 | 7.5 | PET | 94 |
| | (NA, 10) | | | |
| 2 | NALCO 1115 | 10.0 | PET | 87 |
| | (NA, 10) | | | |
| COMP. | NALCO 1115 | 0.0 | Flashlamp- | 97 |
| EX. B | (NA, 10) | | treated PET | |
| 3 | NALCO 1115 | 7.5 | Flashlamp- | >100 |
| | (NA, 10) | | treated PET | |
| 4 | NALCO 1115 | 10.0 | Flashlamp- | >100 |
| | (NA, 10) | | treated PET | |
| COMP. | NALCO 1115/ | 0.0 | PET | <6 |
| EX. C | NALCO 1050 | | | |
| | (30:70, 10) | | | |
| COMP. | NALCO 1115/ | 0.0 | Flashlamp- | 98 |
| EX. D | NALCO 1050 | | treated PET | |
| | (30:70, 10) | | | |
| 5 | NALCO 1115/ | 5.0 | PET | 102 |
| | NALCO 1050 | | | |
| | (30:70, 10) | | | |
| 6 | NALCO 1115/ | 10.0 | PET | 100 |
| | NALCO 1050 | | | |
| | (30:70, 10) | | | |

TABLE 2

| | SILICA | | | CROCK TEST |
|---|---|---|---|---|
| | DISPERSION, | | METAL | CYCLES TO |
| | (weight ratio, | | COMPOUND, | FAILURE |
| EXAM- | total weight | SUB- | (weight percent | WITH PAPER |
| PLE | percent solids) | STRATE | of total solids) | TOWEL |
| COMP. | NALCO 1115/ | PET | none (0.0) | 23 |
| EX. E | NALCO 1050 | | | |
| | (30:70, 10) | | | |
| 7 | NALCO 1115/ | PET | Zr (5) | 100 |
| | NALCO 1050 | | | |
| | (30:70, 10) | | | |
| 8 | NALCO 1115/ | PET | Sn (5) | 34 |
| | NALCO 1050 | | | |
| | (30:70, 10) | | | |
| 9 | NALCO 1115/ | PET | Ti (5) | 41 |
| | NALCO 1050 | | | |
| | (30:70, 10) | | | |
| 10 | NALCO 1115/ | PET | Al (5) | 48 |
| | NALCO 1050 | | | |
| | (30:70, 10) | | | |
| 11 | NALCO 1115/ | PET | Zn (5) | 89 |
| | NALCO 1050 | | | |
| | (30:70, 10) | | | |
| 12 | NALCO 1115/ | PET | Cu (5) | 50 |
| | NALCO 1050 | | | |
| | (30:70, 10) | | | |

### Examples 13-22 and Comparative Examples F-H

Example 13-22 and Comparative Examples F-H were prepared by mixing diluted colloidal silica dispersions NALCO 1115 (10 weight percent solids in water) and NALCO 1050 with a ratio of 50:50 (Example 13 and Comp. Ex. F), 30:70 (Example 14 and Comp. Ex. G and Examples 19-22 and Comp. Ex. H) and 70:30 (for Examples 15-18), respectively, then acidifying with concentrated HNO₃ to pH=2. The metal salts (SnCl₄.5H₂O (10 weight percent solution in water), Zn(NO₃)₂.6H₂O (10 weight percent solution in water), Cu(NO₃)₂.3H₂O (10 weight percent solution in water)) were subsequently added to the respective silica solution of Examples 13-22 to result in metal compound concentration 2.5-10 weight percent to the total solids in the coating mixture. The composition of coating solutions and substrates for each Example 13-22 are summarized below in the Table 1 and 2.

Coated samples for each Example were prepared by coating metal doped silica dispersion using a #12 wire-wound coating rod onto PET, 175 micrometers thick polycarbonate film (hereinafter “PC”) obtained from GE advanced Materials, Pittsfield, Mass. under the trade designation LEXAN 8010), and 86 micrometers thick poly(methyl methacrylate) film (hereinafter “PMMA”) obtained as SCOTCHPAK HEAT SEALABLE POLYESTER FILM from 3M Company (for Examples 15-19) and clear PMMA film from the extrusion of PMMA homopolymer based on CP-82 from Plaskolite (for Examples 19-22). The coated samples were dried at room temperature, and then further heated 10 minutes at 120° C. (for PET and PC substrates) or 80° C. (for PMMA and PMMA substrates).

The samples thus prepared were tested according to the TEST METHODS FOR EVALUATING THE MECHANICAL DURABILITY described above. Results are reported in Tables 3 and 4 (below).

TABLE 3

| | SILICA | | | CROCK TEST |
|---|---|---|---|---|
| | DISPERSION, | | METAL | CYCLES TO |
| | (weight ratio, | | COMPOUND, | FAILURE |
| EXAM- | total weight | SUB- | (weight percent | WITH CROCK |
| PLE | percent solids) | STRATE | of total solids) | CLOTH |
| COMP. | NALCO 1115/ | PET | 0.0 | 22 |
| EX. F | NALCO 1050 | | | |
| | (50:50, 5) | | | |
| 13 | NALCO 1115/ | PET | Sn (7.5) | 29 |
| | NALCO 1050 | | | |
| | (50:50, 5) | | | |
| COMP. | NALCO 1115/ | PC | 0.0 | <4 |
| EX. G | NALCO 1050 | | | |
| | (30:70, 5) | | | |
| 14 | NALCO 1115/ | PC | Zn (7.5) | <68 |
| | NALCO 1050 | | | |
| | (30:70, 5) | | | |
| 15 | NALCO 1115/ | PMMA | 0.0 | 22 |
| | NALCO 1050 | | | |
| | (70:30, 10) | | | |
| 16 | NALCO 1115/ | PMMA | Zn (2.5) | 61 |
| | NALCO 1050 | | | |
| | (70:30, 10) | | | |
| 17 | NALCO 1115/ | PMMA | Zn (5) | 85 |
| | NALCO 1050 | | | |
| | (70:30, 10) | | | |
| 18 | NALCO 1115/ | PMMA | Zn (10) | 100 |
| | NALCO 1050 | | | |
| | (70:30, 10) | | | |

TABLE 4

| | SILICA | | | CROCK TEST | |
|---|---|---|---|---|---|
| | DISPERSION, | | METAL | CYCLES TO | |
| | (weight ratio, | | COMPOUND, | FAILURE | HAZE |
| EXAM- | total weight | SUB- | weight percent | WITH CROCK | INCREASE, |
| PLE | percent solids) | STRATE | of total solids | CLOTH | percent |
| COMP. | NALCO 1115/ | PMMA | 0 | 2000 | 2 |
| EX. H | NALCO 1050 | | | | |
| | (70:30, 10) | | | | |
| 19 | NALCO 1115/ | PMMA | Cu (5) | 4000 | 2 |
| | NALCO 1050 | | | | |
| | (70:30, 10) | | | | |
| 20 | NALCO 1115/ | PMMA | Cu (10) | 6000 | 2 |
| | NALCO 1050 | | | | |
| | (70:30, 10) | | | | |
| 21 | NALCO 1115 | PMMA | Zn (5) | 4000 | 2 |
| | (NA, 10) | | | | |
| 22 | NALCO 1115 | PMMA | Zn (10) | 6000 | 2 |
| | (NA, 10) | | | | |

### Test Method for X-Ray Scattering Analysis

Reflection geometry data were collected in the form of a survey scan by use of a PANalytical Empyrean diffractometer, copper K_{α} radiation, and PIXcel detector registry of the scattered radiation. The diffractometer was fitted with variable incident beam slits and diffracted beam slits. The survey scan was conducted in a coupled continuous mode from 5 to 80 degrees (2θ) using a 0.04 degree step size and 1200 second dwell time. X-ray generator settings of 40 kV and 40 mA were employed.

### Examples 23-24

Examples 23-24 were prepared by coating metal-doped silica dispersions on soda-lime glass substrates (obtained from Brin Northwestern Glass Company, Minneapolis, Minn.) using a #6 wire-wound coating rod (nominal wet coating thickness=14 microns). The metal-doped colloidal silica dispersions were prepared by diluting NALCO 1115 silica sol to 10 weight percent solids with deionized water, acidifying the diluted silica sol with concentrated HNO₃ to a pH of about 2-3—and then adding a desired amount of aqueous metal compound solutions (10 weight percent Cu(NO₃)₂.3H₂O, Zn(NO₃)₂.6H₂O). The type and amount of metal cations added to the coating compositions for Examples 22 and 23 are reported in Table 5. The coated samples were then dried at room temp and then further cured at 120° C. for 10 min. The final coated samples were optically clear and transparent. The powders for analysis were collected by scraping the coating off from glass substrates. The samples thus prepared were analyzed according to the TEST METHOD FOR X-RAY SCATTERING ANALYSIS described above and the results are reported in Table 5.

TABLE 5

| | | AMOUNT OF | |
|---|---|---|---|
| | | ADDED METAL | |
| | | COMPOUND | |
| EXAM- | ADDED METAL | WEIGHT % OF | PHASE |
| PLE | COMPOUND | SOLIDS | PRESENT |
| 23 | Cu(NO₃)₂•3H₂O | 5 | amorphous |
| 24 | Zn(NO₃)₂•6H₂O) | 5 | amorphous |

Other modifications and variations to the present disclosure may be practiced by those of ordinary skill in the art, without departing from the spirit and scope of the present disclosure, which is more particularly set forth in the appended claims. It is understood that aspects of the various embodiments may be interchanged in whole or part or combined with other aspects of the various embodiments. All cited references, patents, or patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1-26. (canceled)

27. A method of making a coatable composition, the method comprising:
providing a first composition comprising silica nanoparticles dispersed in an aqueous liquid medium, wherein the silica nanoparticles have an average particle size of less than or equal to 20 nanometers, wherein the first composition has a pH greater than 6;
acidifying the first composition to a pH of less than or equal to 4 using inorganic acid to provide the coatable composition, wherein the coatable composition comprises agglomerated silica nanoparticles; and
dissolving at least one metal compound in the coatable composition, wherein the metal compound comprises a metal cation having a charge of n+, wherein n represents an integer ≧2.

28. The method of claim 27, wherein said at least one metal compound is selected from the group consisting of tin compounds, zinc compounds, aluminum compounds, zirconium compounds, copper compounds, and combinations thereof.

29. The method of claim 27, wherein the coatable composition is essentially free of organic non-volatile compounds.

30. A coatable composition made according to the method of claim 27.

31. A method of making a wear-resistant article, the method comprising steps:
a) providing a first composition comprising silica nanoparticles dispersed in an aqueous liquid medium, wherein the silica nanoparticles have an average particle size of less than or equal to 20 nanometers, wherein the first composition has a pH greater than 6;
b) acidifying the composition to a pH of less than or equal to 4 using inorganic acid to provide a second composition; and
c) dissolving at least one metal compound in the second composition to provide a coatable composition, wherein the metal compound comprises a metal cation having a charge of n+, wherein n represents an integer ≧2; and
d) coating a layer of the coatable composition onto a surface of a substrate; and
e) at least partially drying the coatable composition to provide a wear-resistant layer.

32. The method of claim 31, wherein said at least one metal compound is selected from the group consisting of tin compounds, zinc compounds, aluminum compounds, zirconium compounds, copper compounds, and combinations thereof.

33. The method of claim 31, wherein the coatable composition is essentially free of organic non-volatile compounds.

34. A wear-resistant article made according to the method of claim 31.

35. The wear-resistant article of claim 34, wherein the article comprises retroreflective sheeting.

36. A wear-resistant composition comprising an amorphous silica matrix containing metal cations, wherein the amorphous silica matrix comprises interconnected spherical silica nanoparticles having a particle size distribution with an average particle size of less than or equal to 8 nanometers, wherein the metal cations have a charge of n+, wherein n represents an integer ≧2, wherein a majority of the metal cations are individually disposed in the amorphous silica matrix, and wherein the metal cations comprise from 0.5 to 20 mole percent of the composition.

37. The wear-resistant composition of claim 36, wherein the metal cations are selected from the group consisting of tin compounds, zinc compounds, aluminum compounds, zirconium compounds, copper compounds, and combinations thereof.

38. The wear-resistant composition of claim 36, wherein the silica nanoparticles have an average particle size of less than or equal to 4 nanometers.

39. The wear-resistant composition of claim 36, wherein the wear-resistant composition is essentially free of organic non-volatile compounds.

40. A wear-resistant article comprising a layer of an amorphous wear-resistant composition disposed on a surface of a substrate, wherein the amorphous wear-resistant composition comprises a silica matrix containing metal cations, wherein the silica matrix comprises interconnected spherical silica nanoparticles having a particle size distribution with an average particle size of less than or equal to 8 nanometers, wherein the metal cations have a charge of n+, wherein n represents an integer ≧2, wherein a majority of the metal cations are individually disposed in the silica matrix, and wherein the metal cations comprise from 0.5 to 20 mole percent of the amorphous wear-resistant composition.

41. The wear-resistant article of claim 40, wherein said at least one metal compound is selected from the group consisting of tin compounds, zinc compounds, aluminum compounds, zirconium compounds, copper compounds, and combinations thereof.

42. The wear-resistant article of claim 40, wherein the silica nanoparticles have an average particle size of less than or equal to 4 nanometers.

43. The wear-resistant article of claim 40, wherein the substrate comprises glass or an organic polymer.

44. The wear-resistant article of claim 43, wherein the organic polymer comprises at least one of polymethyl methacrylate or polyethylene terephthalate.

45. The wear-resistant article of claim 40, wherein the wear-resistant layer has a thickness in a range of from 0.02 to 100 microns.

46. The wear-resistant article of claim 40, wherein the coatable composition is essentially free of organic non-volatile compounds.
